(19) United States
(12) Patent Application Publication
(10) Pub. No.: US 2005/0105714 A1
(43) Pub. Date: May 19, 2005

(54) Communication terminal apparatus and reproducing method

(76) Inventors: Tomoaki Ono, Tachikawa (JP); Ryota Mita, Hitachinaka (JP); Kentarou Nishiya, Higashihiroshima (JP)

Correspondence Address: MCDERMOTT, WILL & EMERY, 600 13th Street, N.W., Washington, DC, 20005-3096, US

(21) Appl. No.: 10/808,604

(22) Filed: Mar. 25, 2004

(30) Foreign Application Priority Data
Nov. 14, 2003 (JP) 2003-384483

(51) Int. Cl. H04H 5/00; H04M 1/00; H04M 3/00

(52) U.S. Cl. 379/373.01; 379/374.01

(57) ABSTRACT

User friendly operation of a communication terminal apparatus equipped with a music reproducing function is improved. The communication terminal apparatus is comprised of a storage unit for storing thereinto a voice signal, and a signal processing unit for stereophonically processing the voice signal stored in the storage unit. When the voice signal is reproduced, the communication terminal apparatus switches a setting condition as to whether or not the voice signal is stereophonically processed by the signal processing unit in response to a peripheral condition of this communication terminal apparatus, an identification signal added to the voice signal, or such a condition as to whether or not an earphone is connected to the communication terminal apparatus.

### BACKGROUND OF THE INVENTION

The present invention is related to a communication terminal apparatus equipped with a music reproducing function.

Conventionally, while music reproducing functions are employed in communication terminal apparatus, telephone calling sounds are outputted by using the music reproducing functions. For instance, such portable telephone apparatus have been disclosed 10 which may notify telephone calls by way of telephone calling sounds adapted to use environments, while tones and melodies of these telephone calling sounds are automatically changed in relation to peripheral environments of these portable telephone apparatus (for instance, refer to Japanese Laid-open Patent Application No. 2001-223767).

In the near future, in order to provide reproductions of music in higher tone qualities to users, stereophonic processing operations of reproduced sounds are necessarily required. However, the portable telephone apparatus disclosed in the above-described patent application has explained the technical idea capable of changing the tones and the melodies of the telephone calling sounds, but has not described such a technical possibility that reproduced sounds are stereophonically processed.

Since housings of portable telephone apparatus have been made more compact, there is an apparent limitation in sizes of speakers which can be mounted on these housings. Basically, maximum sound volumes obtained during reproducing operation are greatly influenced by sizes of mountable speakers. As a result, levels of signals inputted to the speakers are set under such a condition that sounds can be reproduced at possible high levels permitted in the above-described limitation. When reproduced music is stereophonically processed, for instance, since sound components which can be hardly heard in audible levels are added to the original reproduced music signal as effect sounds, the resultant signal level of the reproduced music is increased. As a consequence, if this increased signal level is directly applied to a speaker, then this speaker is driven by such an input signal having a level higher than the maximum input signal level thereof. This may cause such a problem that the reproduced sounds are distorted. To solve this problem, if the signal level is lowered to the same signal level before the music signal is stereophonically processed, then audible sound volumes are lowered. As a result, there are some possibilities that reproduced sounds can be hardly heard. In particular, in the case that reproduced sounds are used to notify telephone calling sounds, when audible sound volumes become low, users can hardly become aware of the telephone calling sounds. As previously explained, since the reproduced music is stereophonically processed, there are some cases that user friendly operations of the above-described communication terminal apparatus are deteriorated.

As a consequence, an object of the invention is to improve a user friendly operation of a communication terminal apparatus equipped with a music reproducing function.

### SUMMARY OF THE INVENTION

To solve the above-described problems, a communication terminal apparatus, according to an aspect of the present invention, is featured by that the communication terminal apparatus is comprised of a storage unit for storing thereinto a voice signal, and a signal processing unit for stereophonically processing the voice signal stored in the storage unit, in which when the voice signal is reproduced, the communication terminal apparatus switches a setting condition as to whether or not the voice signal is stereophonically processed by the signal processing unit in response to a peripheral condition of this communication terminal apparatus, an identification signal added to the voice signal, or such a condition as to whether or not an earphone is connected to the communication terminal apparatus.

In accordance with the present invention, the user friendly operation of the communication terminal apparatus equipped with the music reproducing function can be improved.

Other objects, features and advantages of the invention will become apparent from the following description of the embodiments of the invention taken in conjunction with the accompanying drawings.

### BRIEF DESCRIPTION OF THE DRAWINGS

FIG. 1 is a schematic block diagram for showing an arrangement of a communication terminal apparatus according to an embodiment of the present invention.

FIG. 2 is a diagram for illustratively indicating an example of a display screen of the communication terminal apparatus shown in FIG. 1.

FIG. 3 is a flow chart for describing a telephone-call notifying process operation executed in the communication terminal apparatus shown in FIG. 1.

FIG. 4 is a flow chart for explaining an alarm notifying process operation executed in the communication terminal apparatus of FIG. 1.

### DESCRIPTION OF THE EMBODIMENTS

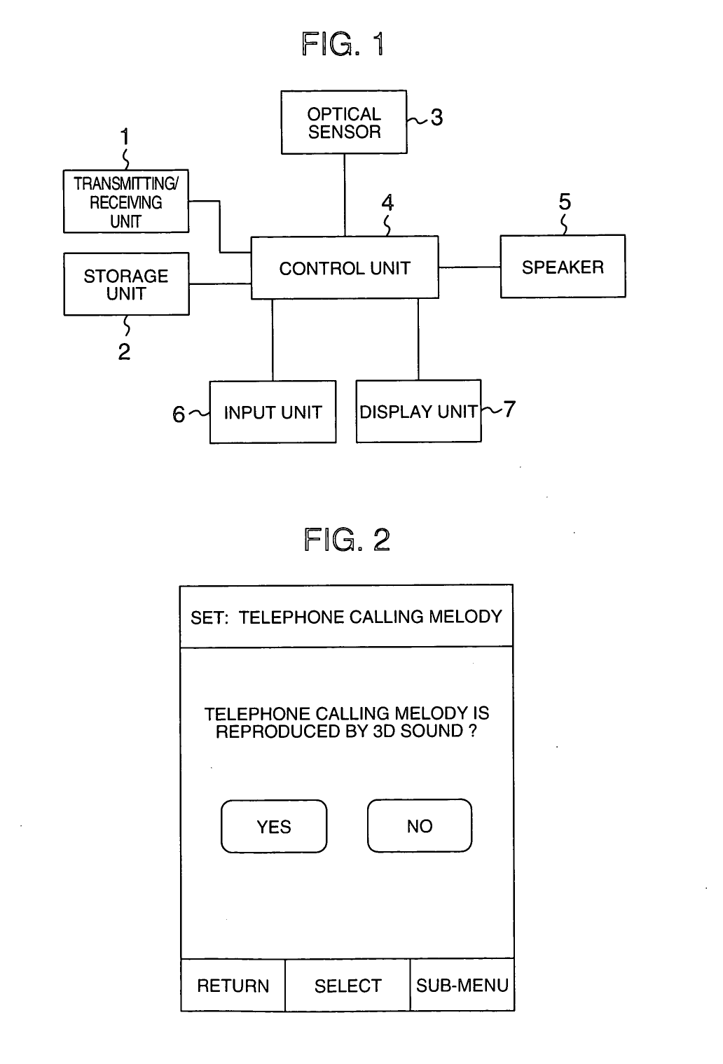

FIG. 1 is a schematic block diagram for showing an arrangement of a communication terminal apparatus according to an embodiment of the present invention. A description is made of the arrangement and operations of the communication terminal apparatus of this embodiment with reference to FIG. 1.

In the communication terminal apparatus, a transmitting/receiving unit 1 transmits and/or receives music data and picture data with respect to an external appliance (not shown). A storage unit 2 stores thereinto the music data and the picture data, which are received from the transmitting/receiving unit 1; data such as a telephone number and a mail address, which are entered by operating an input unit 6 by a user; and a program which is executed by a control unit 4. In the above-described embodiment shown in FIG. 1, all of the entered data and the program are stored in the storage unit 2. However, the present invention is not limited only to this embodiment. Alternatively, while this communication terminal apparatus may be equipped with a plurality of memories, these memories may be separately used so as to store thereinto these data and program in accordance with natures of these data and program. For instance, as to input data, since a removable memory card, or the like may be employed as the storage unit 2, even in such a case that an amount of data which is wanted to be stored is increased, these increased input data may be readily stored into the removable memory card. The input unit 6 is constituted by a plurality of key buttons which involve numeral keys and function keys.

An optical sensor 3 corresponds to a detector for detecting light/dark conditions around the communication terminal apparatus. The function of this optical sensor 3 may be turned ON/OFF in response to operations by a user. For instance, in such a case that the user wants to switch the function of this optical sensor 3 in response to brightness of the peripheral environment of this communication terminal apparatus, the user turns ON the optical sensor 3. To the contrary, in such a case that the user does not want to switch the function of this optical sensor 3 in response to brightness of the peripheral environment of this communication terminal apparatus, the user turns OFF the optical sensor 3.

The control unit 4 controls the respective structural units, and executes data processing operations based upon the program stored in the storage unit 2. In this control unit 4, a signal processing operation for reproducing music data, and another signal processing operation for stereophonically processing reproduced sound are carried out. In this case, as the process operation for stereophonically (three-dimensionally) processing the reproduced sound, for example, harmonic components are synthesized with each other from frequency components which are contained in original telephone calling sound, and when the original telephone calling sound is reproduced, this synthesized harmonic sound component is added to the original telephone calling sound, and then, the resulting telephone calling sound is outputted. However, the process operation for stereophonically processing the reproduced sound is not limited only to this process operation, but may be realized by such a signal processing operation which is performed so as to obtain a three-dimensional effect in a reproduced sound.

A speaker 5 outputs both a music signal and various sorts of signals, which have been processed by the control unit 4. A display unit 7 is constructed of a liquid crystal display screen, or the like. This display unit 7 may display thereon a menu screen, a notification message to the user, and so on.

First, a description is made of such a case that a telephone calling sound is stereophonically (three-dimensionally) processed. The user previously sets as to whether or not a telephone calling sound is stereophonically (3-D) processed by operating the input unit 6, as represented in FIG. 2. This 3-D setting operation may be alternatively carried out every telephone calling sound in the case that the user has previously selected an individual telephone calling sound every telephone caller, and also, has previously selected separate telephone calling sounds with respect to such groups as companies and friends. There is a certain case that the user does not want to stereophonically process certain telephone calling sounds, namely, in the case that some telephone calling sounds are not suitable to be stereophonically processed, and/or the user does not wish to stereophonically process telephone calling sounds issued from a specific group and/or a specific person. As previously explained, since the user presets the 3-D processing operation with respect to each of the selected telephone calling sounds, the stereophonic processing operation may be carried out in accordance with features of telephone calling sounds and utilization modes by the user. It should be understood that when such a 3D-setting data has been added to a telephone calling sound by the writer of telephone calling melody, the control unit 6 executes the sound process operation in accordance with this 3D-setting data irrespective of the user setting condition. This 3D-setting data indicates as to whether or not a reproduced sound is stereophonically processed.

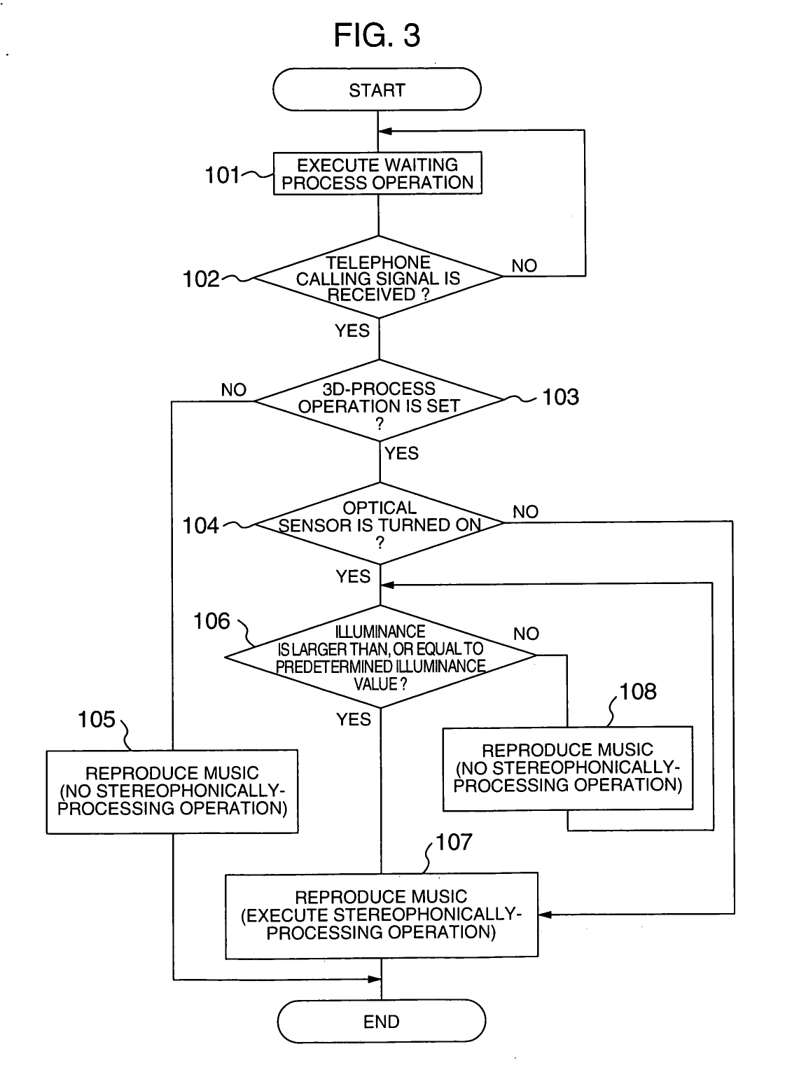

FIG. 3 is a flow chart for explaining a telephone-call notifying process operation executed in the case that the communication terminal apparatus of this embodiment receives a telephone call. In this embodiment, a judgement is made as to whether or not the communication terminal apparatus is put into a bag, or the like based upon brightness of a peripheral environment of this communication terminal apparatus, and then, the function for performing whether or not the telephone calling sound is stereophonically processed is switched in response to the judgement result.

In this telephone-call notifying process operation, the communication terminal apparatus waits to receive a telephone calling signal, and monitors as to whether or not a telephone call is made (step 101). When the control unit 4 detects that the transmitting/receiving unit 1 receives the telephone calling signal (step 102), this control unit 4 judges an to whether or not the function for stereophonically processing the telephone calling sound has been set (step 103).

In such a case that the 3D-setting operation (stereophonic processing function) has not been set, the control unit 4 reproduces the telephone calling sound without performing of the stereophonic sound producing operation (step 105). On the other hand, when the 3D-setting operation has been set, the control unit 4 detects an ON/OFF state of the optical sensor 3 (step 104).

When the optical sensor 3 is turned ON, the optical sensor 3 senses brightness of a peripheral environment of the communication terminal apparatus, and then, outputs this sensed brightness to the control unit 4. When the control unit 4 judges that the sensed brightness is larger than, or equal to a predetermined value (step 106), the control unit 4 executes the stereophonic sound producing process operation, and outputs the telephone calling sound from the speaker 5 (step 107). On the other hand, in such a case that illuminance is smaller than a predetermined illuminance value, the control unit 4 changes the sound level to either a maximum sound level or a sound level which is larger than the sound level set by the user, and then outputs the level-changed telephone calling sound (step 108). In the case that illuminance is larger than, or equal to the predetermined value, the control unit 4 executes the stereophonic processing operation, and then outputs the stereophonically-processed telephone calling sound from the speaker 5.

In the case that the optical sensor 3 is turned OFF, the control unit 4 outputs such a reproduced sound which has been stereophonically processed in accordance with the 3D-setting operation (step 107).

In accordance with the communication terminal apparatus of this embodiment, in the case that the control unit 4 judges that the communication terminal apparatus is not put into the bag, or the like and the peripheral environment thereof is light, the telephone calling sound is stereophonically processed, and thus, the stereophonically-processed telephone calling sound is outputted, so that the telephone calling melody having the high sound quality can be provided to the user. Also, in such a case that the control unit 4 judges that the communication terminal apparatus is put into the bag, or the like, since the stereophonic processing operation is not carried out, the audible sound levels becomes high, so that the original function owned by the telephone calling sound (namely, telephone call is notified to user) is not deteriorated.

Next, an explanation is made of such a case that an alarm sound of, for example, an alarm clock is stereophonically processed. In this embodiment, a function as to whether or not an alarm sound is stereophonically processed is switched in response to brightness of a peripheral environment of the alarm clock. The user previously sets an alarm notifying time instant, previously selects an alarm sound, and previously sets as to whether or not the selected alarm sound is stereophonically processed by using the input unit 6.

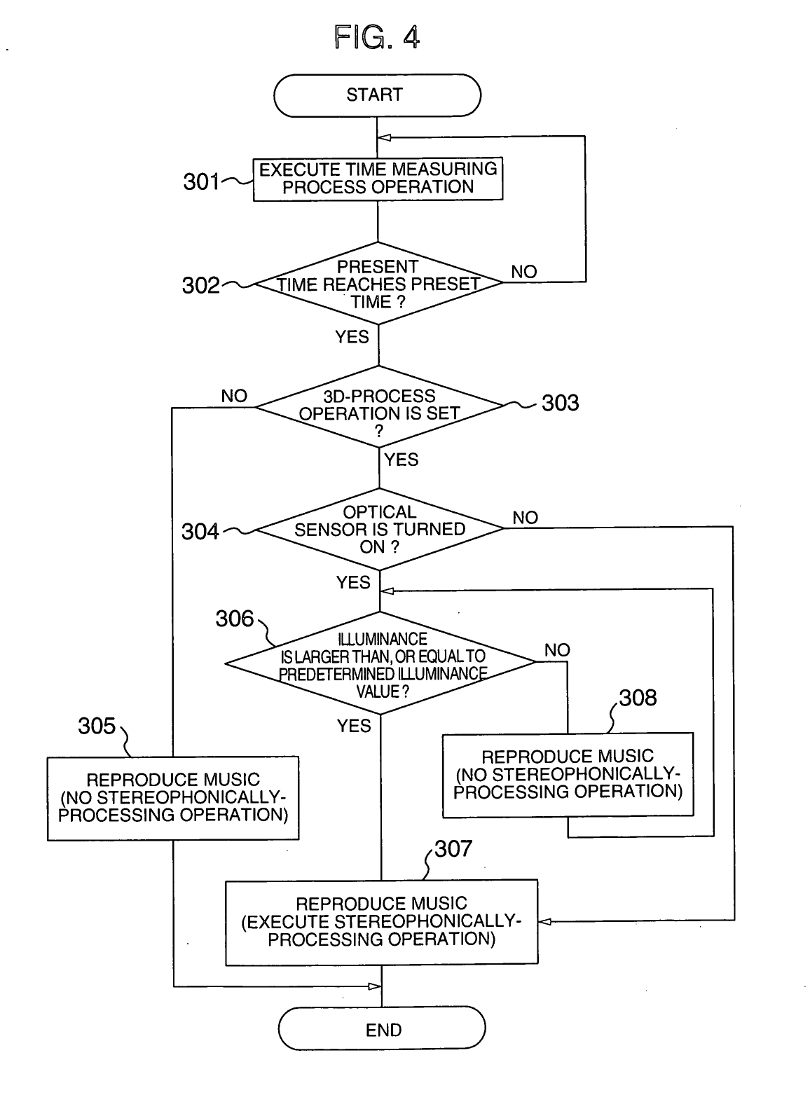

FIG. 4 is a flow chart for describing an alarm notifying process operation. The control unit 4 executes a time measuring process operation (step 301), and when the control unit 4 detects that the present time becomes the preset time instant (step 302), this control unit 4 judges as to whether or not the stereophonic processing operation (3D-seting operation) of the alarm sound has been set (step 303).

In the case that the 3D-setting operation has not been set, the control unit 4 reproduces the alarm sound without executing the stereophonic processing operation of the alarm sound (step 305). On the other hand, in the case that the control unit 4 detects an ON/OFF state of the optical sensor 3 (step 304).

When the optical sensor 3 is turned ON, the optical sensor 3 senses brightness of the peripheral environment of the alarm clock, and then, outputs this sensed brightness to the control unit 4. When the control unit 4 judges that the sensed brightness is larger than, or equal to a predetermined value (step 306), the control unit 4 executes the stereophonic sound producing process operation, and outputs an alarm sound from the speaker 5 (step 307). On the other hand, in such a case that illuminance is smaller than a predetermined illuminance value, the control unit 4 outputs an alarm sound in such a manner that an audible sound level of this alarm sound is increased, while the control unit 4 does not execute the stereophonic processing operation (step 308). In the case that illuminance is larger than, or equal to the predetermined illuminance value, the control unit 4 executes the stereophonic processing operation, and then outputs the stereophonically-processed alarm sound from the speaker 5 in such a manner that a sound quality thereof is improved.

As previously explained, since the setting condition as to whether or not the stereophonic processing operation of the voice data is switched in response to the peripheral environmental condition, while the three-dimensional effect of the alarm notifying sound is achieved so as to improve the sound quality thereof, when the alarm sound of the alarm clock is reproduced in the dark place, the alarm sound having the high sound level can be notified, which can improve the user friendly operation.

Although the optical sensor is mounted on the communication terminal apparatus of the above-described embodiment, the present invention is not limited thereto. Alternatively, for example, while a camera sensor mounted on a communication terminal apparatus may be employed, brightness of a peripheral environment of this communication terminal apparatus may be detected based upon data acquired by this camera sensor. As a result, such an optical sensor is no longer provided on the communication terminal apparatus, and a total number of structural components may be reduced.

Also, in this embodiment, the brightness of the peripheral environment is detected in order to switch the function as to whether or not the stereophonic processing operation of the reproduced sound is carried out, but the present invention in not limited only to this process operation. Alternatively, the stereophonic processing operation of the reproduced sound may be switched by detecting, for instance, such conditions as to whether or not the user takes the communication terminal apparatus on his hand, whether or not an alarm shell type communication terminal apparatus is opened, or whether or not an operation button is depressed. For example, while a touch sensor is employed, the setting operation as to whether or not the stereophonic processing operation is carried out by detecting such a condition as to whether or not the user takes the communication terminal apparatus on his hand.

Furthermore, while it is not determined as to whether or not a stereophonic processing operation of a reproduced sound is carried out based upon a detection result obtained from a state detecting means, the reproduced sound may be firstly outputted without executing the stereophonic processing operation, and after a predetermined time duration has elapsed, the stereophonic processing operation of the reproduced sound may be carried out.

In the above-described embodiment, when either the telephone calling melody or the alarm notifying sound is reproduced, the setting condition as to whether or not the stereophonic processing operation is carried out is switched. However, the present invention is not limited only to this switching operation. Alternatively, the above-described inventive idea of the present invention may be applied to such a case that voice data received from another communication terminal apparatus is reproduced, voice data downloaded from another communication terminal apparatus is reproduced, and voice data stored in a storage medium such as a memory card is reproduced.

For instance, in such a case that data such as movies is reproduced, if stereophonic sounds are reproduced from a speaker with having an attendance feeling, then the stereophonic sounds may give annoying noise to any persons around a user. Also, even when the data is stereophonically processed, there are some possibilities that a user cannot hear this stereophonic sound in a noisy place. In order to solve these difficulties, when an instruction of reproducing data is entered from the user to the control unit 4, the control unit 4 confirms as to whether or not an earphone is connected to the communication terminal apparatus. Then, the control unit 4 controls switching operations in such a manner that when the earphone is connected to the communication terminal apparatus, the control unit 4 performs the stereophonic processing operation. In the case that the earphone is not connected to the communication terminal apparatus, but the reproduced sound is outputted from the speaker 5, the control unit 4 does not execute the stereophonic processing operation. As explained above, since the setting condition as to whether or not the stereophonic process operation is performed is switched in response to such a condition as to whether or not the earphone is connected, the data can be reproduced in connection with the use condition. Alternatively, such a message may be displayed on the display unit 7 before the data is reproduced, namely, “voice is 3D-reproduced”, and “3D-reproduction cannot be performed by speaker. When 3D-reproduction is required, please use earphone.”

Also, it is desirable to employ two switching operations, namely, switching operation for switching the stereophonic processing operation in accordance with the connection of the earphone, and the user himself switches as to whether or not the stereophonic process operation is carried out irrespective of the connection condition. There are some cases that when voice data is received under deteriorated voice quality, if this voice data is stereophonically processed, then the stereophonically processed voice data becomes noisy and therefore the user can hardly hear this voice data. In such a case, since the stereophonic process operation is switched in response to a desirable condition by the user irrespective of the connection condition of the earphone, the user friendly operation can be improved.

Also, in the case of data such as movies, there are some possibilities that the writer does not want to perform the stereophonic processing operation in the communication terminal apparatus. For instance, when an instruction for reproducing the movie data is entered from the user, the control unit 4 confirms as to whether or not prohibit data is contained in a header, or the like of this data to be reproduced. This prohibit data is used to prohibit the stereophonic processing operation. When the prohibit data is contained, the control unit 4 controls the communication terminal apparatus in such a manner that the stereophonic processing operation is not carried out irrespective of the connecting condition of the earphone and also the switching operation for the setting condition by the user. It should be noted that it is preferable to display such a message “3D-reproduction is prohibited” before the data is reproduced. As a result, such a problem can be avoided. That is, the user repeatedly inputs the 3D-reproducing instruction, while the user does not know the prohibition of such a 3D-reproducing operation.

Alternatively, the writer may add recommendation data for recommending a stereophonic processing operation to voice data to be reproduced, not only the prohibit data, and then, may distribute the resultant voice data. In the case that such a voice data attached with the recommendation data is reproduced, after the control unit 4 automatically performs the stereophonic processing operation, the control unit 4 outputs the voice except for such a case that the user has set that the execution of the stereophonic processing operation is prohibited. As a result, the voice data can be reproduced by accepting writing intention of the writer.

It should be further understood by those skilled in the art that although the foregoing description has been made on embodiments of the invention, the invention is not limited thereto and various changes and modifications may be made without departing from the spirit of the invention and the scope of the appended claims.

1. A communication terminal apparatus comprising:
a storage unit for storing thereinto a voice signal;
a signal processing unit for stereophonically processing the voice signal stored in said storage unit in such a manner that said voice signal is outputted as a stereophonic sound;
a detecting unit for detecting a peripheral condition of said communication terminal apparatus; and
a control unit for switching as to whether or not the voice signal is stereophonically processed by said signal processing unit in response to a detection result obtained by said detecting unit.

2. A communication terminal apparatus as claimed in claim 1 wherein:
said detecting unit is an optical sensor for sensing illuminance of a peripheral area of said communication terminal apparatus.

3. A communication terminal apparatus as claimed in claim 2 wherein:
said control unit performs control operations in such a manner that when said illuminance is larger than, or equal to a predetermined illuminance value, the voice signal is stereophonically processed by said signal processing unit, whereas when said illuminance is smaller than said predetermined luminance value, the voice signal is not stereophonically processed by the signal processing unit.

4. A communication terminal apparatus as claimed in claim 1 wherein:
said detecting unit is a touch sensor for sensing as to whether or not the user takes said communication terminal apparatus on his hand.

5. A communication terminal apparatus as claimed in claim 4 wherein:
when the user takes said communication terminal apparatus on his hand, said control unit controls said signal processing unit to stereophonically process the voice signal, whereas when the user does not take said communication terminal apparatus on his hand, said control unit controls said signal processing unit not to stereophonically process the voice signal.

6. A communication terminal apparatus as claimed in claim 1 wherein:
said signal processing unit performs such a process operation that a frequency component contained in the voice signal stored in said storage unit is multiplied by 2, and then, the doubled frequency component is added to said voice signal.

7. A communication terminal apparatus comprising:
a storage unit for storing thereinto a voice signal;
a signal processing unit for stereophonically processing the voice signal stored in said storage unit; and
a control unit for switching as to whether or not the voice signal is stereophonically processed by said signal processing unit in response to identification data added to said voice signal when a reproducing request of the voice signal stored in said storage unit is inputted.

8. A communication terminal apparatus as claimed in claim 7 wherein:
said identification data corresponds to such a data for indicating that the stereophonic processing operation of said voice signal is prohibited; and when said identification data is added to the voice signal, said control unit controls said signal processing unit not to stereophonically process the voice signal.

9. A communication terminal apparatus comprising:
a storage unit for storing thereinto a voice signal;
a signal processing unit for stereophonically processing the voice signal stored in said storage unit;
a speaker for outputting a reproduced voice signal;
a connecting unit for connecting an earphone; and
a control unit controls said signal processing unit in such a manner that when the earphone is connected to said connecting unit, the voice signal is stereophonically processed by said signal processing unit, whereas when the earphone is not connected to said connecting unit, the voice signal is not stereophonically processed by said signal processing unit.

10. A communication terminal apparatus as claimed in claim 9 wherein:
said control unit controls the signal processing unit in such a manner that when data for indicating prohibition of the stereophonic processing operation of the voice signal is added to said voice signal, even in such a case that the earphone is connected to said connecting unit, said signal processing unit does not perform the stereophonic processing operation of the voice signal.

11. A reproducing method wherein:
a voice signal is stored;
in such a case that a reproducing instruction of said voice signal is inputted, when an earphone is connected, a stereophonic processing operation of said voice signal is carried out to reproduce the voice signal, whereas when the earphone is not connected, said voice signal is reproduced without executing the stereophonic processing operation of said voice signal.

12. A reproducing method as claimed in claim 11 wherein:
when the earphone is not connected, such a message that the stereophonic processing operation of said voice signal cannot be carried out is displayed.

13. A reproducing method wherein:
plural sorts of melodies are stored;
one of said plural sorts of melodies is selected as a telephone calling melody which is reproduced when a telephone call is received;
when a telephone call is received, illuminance of a peripheral area is detected; and
when said detected illuminance is larger than, or equal to a predetermined illuminance value, said selected telephone calling melody is processed as a stereophonic sound to be reproduced, whereas when said detected illuminance is smaller than said predetermined illuminance value, said selected telephone calling melody is reproduced without executing a stereophonic sound processing operation.

14. A reproducing method wherein:
plural sorts of voice signals are stored;
one of said plural sorts of voice signals is selected as a notification sound;
a reproducing time instant when said notification sound is reproduced is set;
when said reproducing time comes said reproducing time instant, illuminance of a peripheral area is detected; and
when said detected illuminance is larger than, or equal to a predetermined illuminance value, said selected voice signal is processed as a stereophonic sound to be reproduced, whereas when said detected illuminance is smaller than said predetermined illuminance value, said selected voice signal is reproduced without executing a stereophonic processing operation.

15. A reproducing method as claimed in claim 14 wherein:
when said detected illuminance is larger than, or equal to the predetermined illuminance value, a sound level at which said voice signal is reproduced is made lower than that when said detected illuminance is smaller than the predetermined illuminance value.

16. A communication terminal apparatus in claim 1 wherein:
a voice processed by said signal processing unit is a 3D-voice.

17. A reproducing method as claimed in claim 11 wherein:
the stereophonic processing operation is 3D-reproducting operation.
